(19) United States
(12) Patent Application Publication
(10) Pub. No.: US 2015/0176719 A1
(43) Pub. Date: Jun. 25, 2015

(54) METHOD AND APPARATUS FOR DETECTING OPENING AND CLOSING OF PILOT OPERATED SOLENOID VALVE FOR HYDROGEN TANK

(71) Applicants: Hyundai Motor Company, Seoul (KR); Kia Motors Corporation, Seoul (KR)

(72) Inventors: Ji Hyun Shim, Busan (KR); Hyung Ki Kim, Seoul (KR); Chang Ho Kim, Yongin (KR)

(73) Assignees: KIA MOTORS CORPORATION, Seoul (KR); HYUNDAI MOTOR COMPANY, Seoul (KR)

(21) Appl. No.: 14/482,264

(22) Filed: Sep. 10, 2014

(30) Foreign Application Priority Data
Dec. 20, 2013 (KR) 10-2013-0160058

(51) Int. Cl. F16K 31/06; F16K 39/00

(52) U.S. Cl. CPC F16K 31/06; F16K 39/00

(57) ABSTRACT

A method and an apparatus for detecting an opening and closing of a pilot operated solenoid valve provided in a hydrogen tank can open or cut off a channel of hydrogen gas supplied to a stack. The method includes receiving a valve opening command; determining whether valve driving input/output signals responding to the valve opening command are abnormal; checking a pressure inside a high pressure hydrogen pipe when it is determined that the valve driving input/output signals are normal; and outputting a valve opening signal when the checked pressure satisfies a valve opening condition.

### CROSS-REFERENCE TO RELATED APPLICATION

This application claims under 35 U.S.C. §119(a) the benefit of Korean Patent Application No. 10-2013-0160058 filed on Dec. 20, 2013, the entire contents of which are incorporated herein by reference.

### BACKGROUND

(a) Technical Field

The present disclosure relates to an apparatus and a method for detecting an opening and closing of a pilot operated solenoid valve for a hydrogen tank. More particularly, the present disclosure relates to an apparatus and a method for determining an opening and closing of a pilot operated solenoid valve which is used in a hydrogen tank and opens or cuts-off a channel of hydrogen gas supplied to a stack.

(b) Description of the Related Art

A core element of a fuel cell vehicle to obtain propulsion power of a vehicle using a chemical reaction of hydrogen and oxygen may include a stack in which hydrogen reacts with oxygen, stack peripheral parts, and a hydrogen storage system.

Typically, a high pressure hydrogen storage method is used, which is a technology which may be currently commercialized for a hydrogen storage system. Core elements of the high pressure hydrogen storage technology may include a hydrogen storage vessel, a solenoid valve for high pressure hydrogen, and a high pressure regulator.

The solenoid valve may be generally divided into a direct drive type and a pilot valve type. The direct drive type is a method for moving a plunger stopping one orifice to a solenoid unit and has a simple structure.

On the other hand, the pilot valve type is divided into two types of channels, a main channel and a pilot channel, and opens the pilot channel when the plunger stopping the pilot channel is operated by the solenoid unit. The pilot valve type is based on a principle of opening the pilot channel to make a pressure around the main channel equal to that of the tank and opening the plunger stopping the main channel when the two pressures are the same.

The pilot valve type solenoid valve has an advantage that a high pressure valve may be opened with a small force (solenoid). A pressure used in the fuel cell vehicle is approximately 700 bar, which is a considerably high pressure. Therefore, the pilot valve type solenoid valve is mainly used to smoothly drive the valve with small force through the solenoid under the high pressure condition.

Meanwhile, a method for driving the solenoid unit including the solenoid valve is generally divided into two methods of a DC constant voltage application type, and a PWM application type. The DC constant voltage application type has an advantage in that a constant current may be consumed and an operation is simple, but has a disadvantage in that current consumption may not be reduced and heat is generated from the solenoid in the long term.

On the other hand, the PWM application type has a more complicated operation than the DC application type, but may control a current to reduce the heat generation of the solenoid and power consumption by using a method for applying a large current at an early time when a large current is required and keeping the valve in an opened state with a small current.

In the case of the pilot operated solenoid valve controlled by the above method, a large difference in valve opening time is shown due to a pressure difference between an inside and an outside of the tank.

Describing in detail the difference, in the case in which a pressure inside the tank is equal to that outside the tank, that is, the pressure inside the tank is equal to that of a high pressure pipe, when a valve opening signal is applied, the pilot operated solenoid valve is completely opened while the pilot channel is opened immediately after the main channel is opened.

On the other hand, in the case in which the pressure inside the tank is not equal to that outside the tank, when the valve opening signal is applied, the main channel is opened but the pilot channel is not opened immediately after the main channel is opened, but the pilot channel is opened after a predetermined time elapses until the pressure inside the tank is equal to that outside the tank.

Therefore, in the case in which the pressure inside the tank is not equal to that outside the tank, as described above, since the valve is not completely opened until the time when the same pressure condition is formed elapses, a time delay to supply the valve opening signal and the hydrogen actually generated at the time of opening the valve to the stack occurs.

Since the hydrogen storage system has a high pressure environment of about 700 bar, it is difficult to mount a position sensor, and the like for the plunger so as to directly detect the position of the valve. Therefore, it may not been checked by the sensor whether the valve is opened, and thus it is difficult to find out the accurate time when the fuel is supplied to the stack.

Meanwhile, due to the time delay problem of the supply of hydrogen, the problem that it is difficult to mount the sensor, and the like, the related art uses a method for calculating the time when the hydrogen is supplied to the stack under a very severe condition as in the case in which the pressure inside the tank of 700 bar at the time of designing the hydrogen tank and the pressure inside the pipe are not present.

Therefore, there is a need for the development of a new method and apparatus for detecting an opening and closing of a pilot operated solenoid valve for a hydrogen tank.

The above information disclosed in this Background section is only for enhancement of understanding of the background of the invention and therefore it may contain information that does not form the prior art that is already known in this country to a person of ordinary skill in the art.

### SUMMARY

The present disclosure provides an apparatus and a method for detecting an opening and closing of a pilot operated solenoid valve for a hydrogen tank capable of rapidly and accurately determining whether the valve is opened by using the existing facilities without adding a separate sensor.

In one aspect, the present disclosure provides a method for detecting an opening and closing of a pilot operated solenoid valve for a hydrogen tank, the method including: receiving a valve opening command; determining whether valve driving input/output signals responding to the valve opening command are abnormal; checking a pressure inside a high pressure hydrogen pipe when it is determined that the valve driving input/output signals are normal; and outputting a valve opening signal when the checked pressure satisfies a valve opening condition.

In an exemplary embodiment, the method for detecting an opening and closing of a pilot operated solenoid valve for a hydrogen tank may further include: prior to the receiving of the valve opening command, readying to wait for the input of the valve opening command, wherein in the readying, the valve closing signal may be output.

In another exemplary embodiment, if it is determined that the valve driving input/output signals are abnormal by comparing the valve driving input/output signals, the process may proceed to the readying to output the valve closing signal.

In still another exemplary embodiment, the valve opening condition may be set to measure the pressure inside the high pressure hydrogen pipe at a predetermined period and determine that the valve is opened when the pressure difference is maintained at a value of a preset reference pressure or less for a preset reference time or more by comparing the continuously measured values.

In yet another exemplary embodiment, the valve opening condition may be set to measure the pressure inside the high pressure hydrogen pipe at a period of about 100 ms and determine that the valve is opened when the pressure difference is maintained at a value of 2 MPa or less for 500 ms or more by comparing the continuously measured values.

In still yet another exemplary embodiment, in the checking of the pressure, it may be determined that the valve is closed before the valve opening condition is satisfied to output the valve closing signal.

In a further exemplary embodiment, the valve driving input/output signals may be PWM input/output signals.

In another aspect, the present disclosure provides an apparatus for detecting an opening and closing of a pilot operated solenoid valve for a hydrogen tank, the apparatus including: a pilot operated solenoid valve arranged at an outlet of the hydrogen tank; a high pressure hydrogen pipe configured to connect between the pilot operated solenoid valve and a fuel cell stack; a pressure sensor arranged in the high pressure hydrogen pipe to measure the pressure inside the pipe; and a controller configured to determine whether the pilot operated solenoid valve is opened, wherein the controller is configured to receive a pressure inside the pipe from the pressure sensor to determine that the valve is opened when the change in pressure inside the pipe satisfies the preset valve opening condition and output the valve opening signal.

In an exemplary embodiment, the controller may be configured to receive a valve opening command from an upper controller, output a valve closing signal prior to receiving the valve opening command, and determine whether the valve is opened based on whether the valve opening condition is satisfied only when receiving the valve opening command.

In another exemplary embodiment, the controller may be configured to determine whether the valve is opened based on whether the valve opening condition is satisfied only when valve driving input/output signals are not abnormal by comparing the valve driving input/output signals at the time of inputting the valve opening command and if it is determined that the valve driving input/output signals are abnormal, output a valve closing signal.

In still another exemplary embodiment, the valve opening condition may be set to measure the pressure inside the high pressure hydrogen pipe at a predetermined period and determine that the valve is opened when the pressure difference is maintained at a value of a preset reference pressure or less for a preset reference time or more by comparing the continuously measured values.

In yet another exemplary embodiment, the valve opening condition may be set to measure the pressure inside the high pressure hydrogen pipe at a period of about 100 ms and determine that the valve is opened when the pressure difference is maintained at a value of 2 MPa or less for 500 ms or more by comparing the continuously measured values.

In still yet another exemplary embodiment, the valve driving input/output signals may be PWM input/output signals.

As described above, the method and apparatus for detecting an opening and closing of a pilot operated solenoid valve for a hydrogen tank according to the exemplary embodiments of the present disclosure have as follows.

First, according to the exemplary embodiments of the present disclosure, it is possible to immediately determine accurately the valve opening/closing state inside the high pressure solenoid valve.

Second, according to the method and apparatus for detecting an opening and closing of a pilot operated solenoid valve for a hydrogen tank in accordance with the exemplary embodiments of the present disclosure, it is possible to save costs and remove the disadvantages of the layout required to mount the sensor unit since the sensor unit for sensing the opening and closing of the valve is not required.

Third, according to the exemplary embodiments of the present disclosure, it is possible to improve the durability of the facilities since the components, such as the sensor unit, which do not have sufficient durability in the high pressure environment are not required.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a flow chart schematically illustrating processes of a method for detecting an opening and closing of a pilot operated solenoid valve for a hydrogen tank according to an exemplary embodiment of the present disclosure; and

FIG. 2 is a graph illustrating a determination on whether the valve is opened by the method and apparatus for detecting an opening and closing of a pilot operated solenoid valve for a hydrogen tank according to the exemplary embodiment of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present disclosure so as to be easily practiced by a person skilled in the art to which the present disclosure pertains will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure relates to a method and an apparatus for detecting an opening and closing of a pilot operated solenoid valve for a hydrogen tank and provides an apparatus and a method capable of immediately detecting whether a valve is opened by using a pressure sensor which is equipped in a hydrogen storage and supply system without adding a position sensor checking a valve opening.

Hereinafter, a method and an apparatus for detecting an opening and closing of a pilot operated solenoid valve for a hydrogen tank according to an exemplary embodiment of the present disclosure will be described in detail with reference to the accompanying drawings.

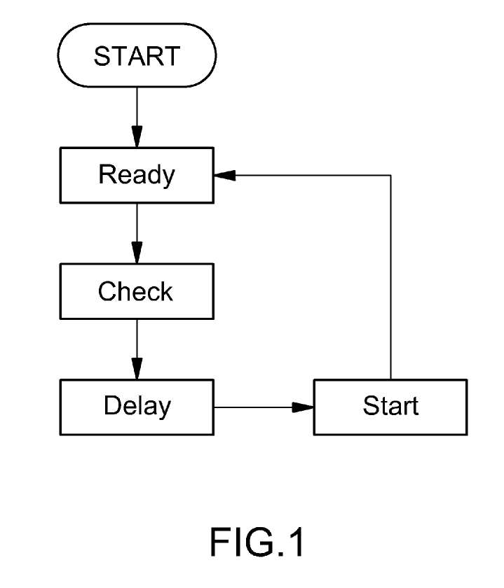

FIG. 1 schematically illustrates processes of a method for detecting an opening and closing of a pilot operated solenoid valve for a hydrogen tank according to an exemplary embodiment of the present disclosure.

As illustrated in FIG. 1, the method for detecting an opening and closing of a pilot operated solenoid valve for a hydrogen tank may include readying to wait for a valve opening command of an upper controller, checking to determine whether valve driving input/output signals responding to the valve opening command are abnormal, delaying to wait for an appropriate time for a predetermined valve opening condition by detecting a pressure inside a hydrogen high pressure pipe, and starting to output a valve opening signal by determining that the valve is opened when the valve opening condition is satisfied.

Each of the processes is required to check whether the valve is opened completely in response to the first valve opening command of the upper controller.

In particular, according to the exemplary embodiment of the present disclosure, the method for detecting an opening and closing of a pilot operated solenoid valve for a hydrogen tank is configured to determine whether the valve is actually opened based on the change in pressure inside the high pressure pipe and determine the valve opening time based on the change in pressure inside the pipe by considering the time when the valve is completely opened and thus approaches a pressure balance inside the pipe as the valve opening time.

In particular, according to the method for detecting an opening and closing of a pilot operated solenoid valve for a hydrogen tank according to the exemplary embodiment of the present, in the readying, the valve opening command of the upper controller is waited for. Herein, a feedback signal for the valve state is output as closing.

When the valve opening command is received from the upper controller, the process proceeds to the checking and during the checking, it is checked whether the valve driving input/output signals are abnormal. In particular, when the valve opening command is received from the upper controller, the input/output signals for driving the valve are generated. In the present process (checking), it is determined whether the valve driving input/output signals are abnormal, and thus it is determined whether a valve driving circuit, a solenoid wire coil, or the like are damaged. Preferably, the valve driving input/output signals may be PWM input/output signals.

When the valve driving input/output signals are abnormal, the process returns to the readying to output a valve closing signal.

Meanwhile, by considering the valve driving input/output signals as a normal state when the valve driving input/output signals are normal, the detailed processes for determining whether the valve is opened are performed.

These processes are represented by the delaying step in FIG. 1, and according to the present disclosure, in the delaying step, a pressure inside a high pressure hydrogen line, which is a parameter to determine whether the valve is opened, is monitored in real time and it is determined whether the valve opening condition is satisfied based on the monitored result.

The valve opening condition needs to be set as a condition determining whether the valve is opened in relation with the pressure, and is preferably determined based on whether a pressure difference of a predetermined level or less is continued for a predetermined time.

In particular, if it is determined that the valve is opened, when the pressure inside the hydrogen pipe is increased until the pressure inside the hydrogen tank is equal to the pressure outside the hydrogen tank, and then the pressure inside the tank and the pressure outside the tank reach a balance state, the valve is completely opened. Therefore, the valve needs to be set in consideration of the pressure condition.

In particular, the valve opening condition is set to measure the pressure inside the high pressure hydrogen pipe at a predetermined period and determine that the valve is opened when the pressure difference is maintained at a value of a preset reference pressure or less for a preset reference time or more by comparing the continuously measured values.

Preferably, in the valve opening condition, the period to measure the pressure inside the high pressure hydrogen pipe may be set to be about 100 ms and the reference of the pressure difference may be set to be 2 MPa. Further, the valve opening condition may be set to determine that the valve is opened only when the pressure difference is maintained at 500 ms or more.

However, the valve opening condition is not limited to the above numerical range, and a pressure measuring period, a reference value of the pressure difference, a pressure difference duration, and the like may be appropriately set in consideration of the change in pressure inside the high pressure hydrogen pipe, the time taken to change the pressure, and the like.

Therefore, when the valve satisfies the predetermined valve opening condition, it may be determined that the valve is completely opened and therefore the valve opening signal is output.

Meanwhile, during the checking, it may be determined that the valve is closed before the valve satisfies the valve opening condition, and therefore the process proceeds to the starting and thus the valve closing signal is output.

When the valve opening command of the upper controller is again changed to the valve closing command, the process again returns from the starting to the readying and thus in the readying, the valve opening signal is again output.

Therefore, according to the method for detecting an opening and closing of a pilot operated solenoid valve for a hydrogen tank according to the exemplary embodiment of the present disclosure, it may be accurately determined whether the valve is opened by using the pressure sensor generally equipped in the high pressure hydrogen line even though a separate kind of sensor for determining whether the valve is opened is not added, thereby providing the accurate valve opening timing.

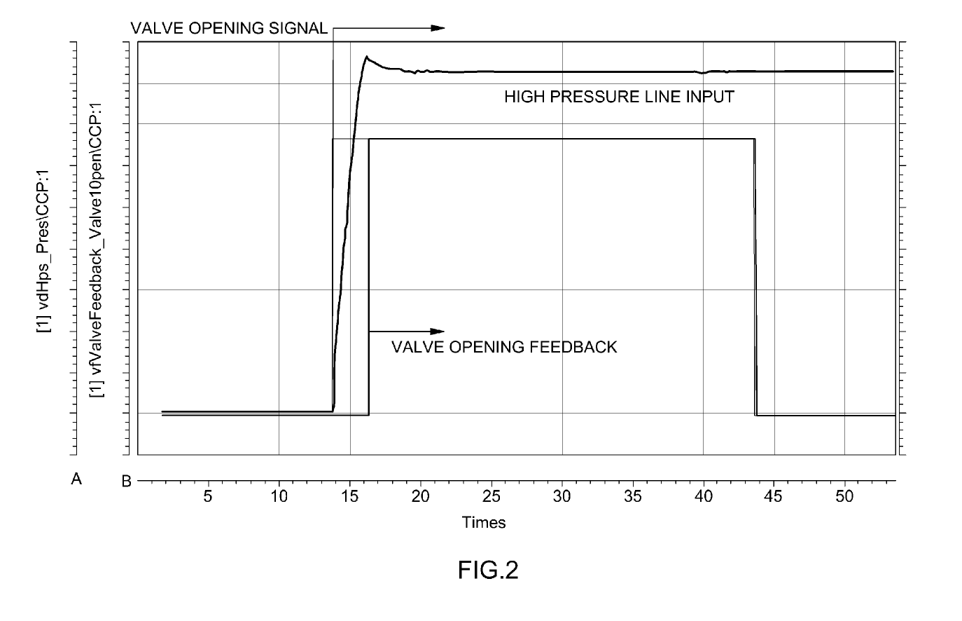

FIG. 2 is a graph illustrating a determination on whether the valve is opened by the method for detecting an opening and closing of a pilot operated solenoid valve for a hydrogen tank according to the exemplary embodiment of the present disclosure.

As illustrated in FIG. 2, when the valve opening command (valve opening signal) is issued, the pressure inside the high pressure line is largely increased and therefore the valve satisfies the valve opening condition which approximates the pressure balance state at the time when the pressure difference detected at a predetermined period is equal to or less than a predetermined reference value, that is, in FIG. 2, in the area in which the pressure inside the high pressure line is suddenly increased, bent and then smoothly reduced, such that the valve opening signal is output as the feedback signal at this point.

Meanwhile, the apparatus for detecting an opening and closing of a pilot operated solenoid valve for a hydrogen tank according to the exemplary embodiment of the present disclosure may be simply configured by including a controller including a determination logic on whether the pilot operated solenoid valve as described above is opened in the hydrogen storage system.

In particular, the apparatus for detecting an opening and closing of a pilot operated solenoid valve for a hydrogen tank may be configured to further include a pilot operated solenoid valve which is equipped at an outlet of the hydrogen tank; a high pressure hydrogen pipe which connects between the pilot operated solenoid valve and a fuel cell stack; and a controller determining whether the pilot operated solenoid valve is opened, along with a general component like the pressure sensor which is equipped in the high pressure hydrogen pipe to measure the pressure inside the pipe.

In this configuration, the controller is configured as a controller which adopts a predetermined determination logic for determining whether the valve is opened as described above.

Therefore, the apparatus for detecting an opening and closing of a pilot operated solenoid valve for a hydrogen tank according to the exemplary embodiment of the present disclosure determines only whether the predetermined valve opening condition is satisfied based on the pressure measuring value detected by the pressure sensor which is equipped in the high pressure hydrogen line, thereby simply detecting whether the valve is opened.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for detecting an opening and closing of a pilot operated solenoid valve for a hydrogen tank, the method comprising:
receiving a valve opening command;
determining whether valve driving input/output signals responding to the valve opening command are abnormal;
checking a pressure inside a high pressure hydrogen pipe when it is determined that the valve driving input/output signals are normal; and
outputting a valve opening signal when the checked pressure satisfies a valve opening condition.

2. The method of claim 1, further comprising:
prior to receiving the valve opening command, readying to wait for the input of the valve opening command, wherein in the readying, a valve closing signal is output.

3. The method of claim 2, wherein if it is determined that the valve driving input/output signals are abnormal by comparing the valve driving input/output signals, the process proceeds to the readying to output the valve closing signal.

4. The method of claim 1, wherein the valve opening condition is set to measure the pressure inside the high pressure hydrogen pipe at a predetermined period and determine that the valve is opened when a pressure difference is maintained at a value of a preset reference pressure or less for a preset reference time or more by comparing continuously measured values.

5. The method of claim 1, wherein the valve opening condition is set to measure the pressure inside the high pressure hydrogen pipe at a period of about 100 ms and determine that the valve is opened when a pressure difference is maintained at a value of 2 MPa or less for 500 ms or more by comparing continuously measured values.

6. The method of claim 1, wherein in the checking of the pressure, it is determined that the valve is closed before the valve opening condition is satisfied to output the valve closing signal.

7. The method of claim 1, wherein the valve driving input/output signals are PWM input/output signals.

8. An apparatus for detecting an opening and closing of a pilot operated solenoid valve for a hydrogen tank, the apparatus comprising:
a pilot operated solenoid valve arranged at an outlet of the hydrogen tank;
a high pressure hydrogen pipe configured to connect between the pilot operated solenoid valve and a fuel cell stack;
a pressure sensor arranged in the high pressure hydrogen pipe to measure the pressure inside the pipe; and
a controller configured to determine whether the pilot operated solenoid valve is opened,
wherein the controller is configured to receive a pressure inside the pipe from the pressure sensor to determine that the valve is opened when the change in pressure inside the pipe satisfies a preset valve opening condition and output a valve opening signal.

9. The apparatus of claim 8, wherein the controller is configured to receive a valve opening command from an upper controller, output a valve closing signal prior to receiving the valve opening command, and determine whether the valve is opened based on whether the valve opening condition is satisfied only when receiving the valve opening command.

10. The apparatus of claim 9, wherein the controller is configured to determine whether the valve is opened based on whether the valve opening condition is satisfied only when valve driving input/output signals are not abnormal by comparing the valve driving input/output signals at the time of inputting the valve opening command and if it is determined that the valve driving input/output signals are abnormal, output a valve closing signal.

11. The apparatus of claim 8, wherein the valve opening condition is set to measure the pressure inside the high pressure hydrogen pipe at a predetermined period and determine that the valve is opened when a pressure difference is maintained at a value of a preset reference pressure or less for a preset reference time or more by comparing the continuously measured values.

12. The apparatus of claim 8, wherein the valve opening condition is set to measure the pressure inside the high pressure hydrogen pipe at a period of about 100 ms and determine that the valve is opened when a pressure difference is maintained at a value of 2 MPa or less for 500 ms or more by comparing the continuously measured values.

13. The apparatus of claim 10, wherein the valve driving input/output signals are PWM input/output signals.
